(19) United States
(12) Patent Application Publication
(10) Pub. No.: US 2012/0206638 A1
(43) Pub. Date: Aug. 16, 2012

(54) LIQUID CRYSTAL DISPLAY DEVICE, IMAGE DISPLAY METHOD, PROGRAM AND RECORDING MEDIUM

(75) Inventor: Kohji Saitoh, Osaka-shi (JP)

(73) Assignee: SHARP KABUSHIKI KAISHA, Osaka-shi, Osaka (JP)

(21) Appl. No.: 13/499,958

(22) PCT Filed: Jun. 9, 2010
(86) PCT No.: PCT/JP10/59783

§ 371 Date: Apr. 3, 2012

(30) Foreign Application Priority Data
Oct. 9, 2009 (JP) 2009-235736

(51) Int. Cl. G09G 3/36; H04N 5/225; G09G 5/02

(52) U.S. Cl. 348/333.05; 345/694; 345/89; 348/E05.024

(57) ABSTRACT

A liquid crystal display device (100) of the present invention includes: a region dividing section (151) for dividing a liquid crystal display section (170) into a plurality of regions; a region determining section (152) for determining which region is a first region where a natural image is displayed and which region is a second region where an artificial image is displayed; a viewing angle setting section (153) which (i) sets a viewing angle so that the viewing angle is increased in the first region where a natural image is displayed and (ii) does not set the viewing angle so that the viewing angle is increased in the second region where an artificial image is displayed. This can display the artificial image, without deteriorating a display quality of the artificial image, even in a case of simultaneously displaying the natural image and the artificial image.

### TECHNICAL FIELD

The present invention relates to (i) a liquid crystal display device including a liquid crystal panel capable of increasing a viewing angle by use of a halftone grayscale method and (ii) an image display method for use in the liquid crystal display device.

### BACKGROUND ART

In recent years, a liquid crystal display device including a liquid crystal panel has been variously used, for example, in an electric device such as a television receiver, a mobile phone, or a digital camera. In some usages, many cases are supposed where several people seem to simultaneously view information displayed on a liquid crystal panel of a liquid crystal display device. In view of the circumstances, many liquid crystal display devices have been developed, each of which can control a viewing angle of the liquid crystal panel to be increased in a case where several people simultaneously view the liquid crystal panel. For example, Patent Literature 1 discloses a technique for setting display means so as to increase a viewing angle in a case where several people are expected to view information displayed on the display means (i.e., in a case where an image or a video image which has been image-captured is displayed on the display means), as compared with a case where only a single user is expected to view the information displayed on the display means.

### CITATION LIST

### Patent Literature

Patent Literature 1
Japanese Patent Application Publication, Tokukai, No. 2004-233527 A (Publication date: Aug. 19, 2004)

### SUMMARY OF INVENTION

### Technical Problem

A technique for increasing a viewing angle of a liquid crystal panel can be exemplified by a halftone grayscale method. An improvement in viewing angle by use of the halftone grayscale method, however, causes coarseness in an edge part of an artificial image which shows a letter or a geometrical pattern such as a figure (i.e., jaggies occur at the edge part). This ultimately causes a deterioration in display quality.

Particularly in a recent liquid crystal display device, an amount of information displayed on a single screen has been increased. In such a device, the single screen often displays simultaneously letter information and an image (video image). Under the circumstances, there are many cases where a screen simultaneously displays (i) an artificial image (which shows letter information or a geometrical pattern such as a figure) and (ii) a natural image, even in a mode in which a natural image is displayed.

In this case, if whether to increase a viewing angle is set for each mode, like the technique disclosed in Patent Literature 1, then a problem is caused that an artificial image, which is displayed simultaneously with a natural image, will have a deteriorated display quality.

The present invention has been made in view of the problem, and a main object of the present invention is to provide a liquid crystal display device which can display an artificial image, without deteriorating a display quality of the artificial image, even in a case of simultaneously displaying a natural image and the artificial image.

### Solution to Problem

In order to attain the object, a liquid crystal display device of the present invention in which a viewing angle of a liquid crystal panel can be increased by setting adjacent two pixels so that one of the adjacent two pixels has a gamma value higher than a predetermined reference gamma value and the other of the adjacent two pixels has a gamma value lower than the predetermined reference gamma value, said liquid crystal display device includes: region dividing means for dividing a display region of the liquid crystal panel into (a) a first region where a natural image is displayed and (b) a second region where an artificial image is displayed; and display means for (i) displaying the natural image by driving a pixel in the first region so that a viewing angle is increased and (ii) displaying the artificial image by driving a pixel in the second region so that a viewing angle is not increased.

In the liquid crystal display device of the present invention, the liquid crystal display section is divided into (a) the first region where the natural image is displayed and (b) the second region where the artificial image is displayed. The liquid crystal display device displays (i) an image by driving the pixel in the first region so that the viewing angle is increased and (ii) an image by driving the pixel in the second region so that the viewing angle is not increased. In other words, the liquid crystal display device of the present invention is set to increase the viewing angle only in a case of the first region where the natural image is displayed.

Accordingly, the liquid crystal display device of the present invention drives only the pixel in a region where a natural image is displayed so as to increase the viewing angle. This can prevent the artificial image from deteriorating the display quality of the artificial image in a case where the liquid crystal display device simultaneously displays the natural image and the artificial image.

### Advantageous Effects of Invention

A liquid crystal display device of the present invention, a display region of a liquid crystal panel is divided into (a) a first region where a natural image is displayed and (b) a second region where an artificial image is displayed. The liquid crystal display device displays (i) an image by driving the pixel in the first region so that the viewing angle is increased and (ii) an image by driving the pixel in the second region so that the viewing angle is not increased.

Accordingly, the liquid crystal display device of the present invention drives only the pixel in the region where a natural image is displayed so as to increase the viewing angle. This can prevent the artificial image from deteriorating the display quality of the artificial image in a case where the liquid crystal display device simultaneously displays the natural image and the artificial image.

### BRIEF DESCRIPTION OF DRAWINGS

FIG. 1 is a block diagram illustrating a main configuration of a liquid crystal display device in accordance with the present invention.

FIG. 2 is a view illustrating an example display where a liquid crystal display device in accordance with the present invention simultaneously displays a natural image and an artificial image in a case where the liquid crystal display device is employed as a digital still camera.

FIG. 3 is a view illustrating an example display where a liquid crystal display device in accordance with the present invention simultaneously displays a natural image and an artificial image in a case where the liquid crystal display device is employed as a mobile phone.

FIG. 4 is a view illustrating an example display where a liquid crystal display device in accordance with the present invention simultaneously displays a natural image and an artificial image in a case where the liquid crystal display device is employed as a television receiver.

FIG. 5 is a view illustrating a modified example where a liquid crystal display device in accordance with the present invention simultaneously displays a natural image and an artificial image in a case where the liquid crystal display device is employed as a television receiver.

### DESCRIPTION OF EMBODIMENTS

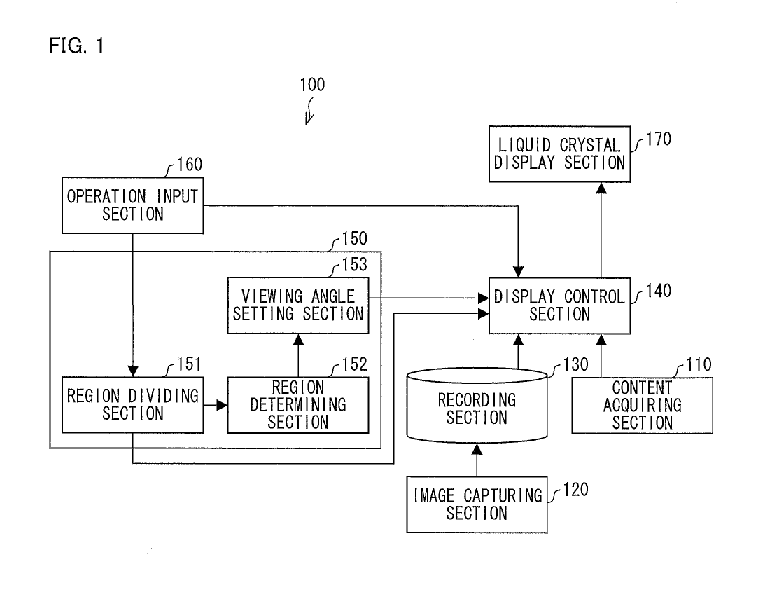

An embodiment of a liquid crystal display device in accordance with the present invention will be described below with reference to FIG. 1 through FIG. 5.

(Configuration of Liquid Crystal Display Device 100)

First, a configuration of a liquid crystal display device in accordance with the present invention will be described below with reference to FIG. 1. FIG. 1 is a block diagram illustrating a main configuration of a liquid crystal display device 100.

As illustrated in FIG. 1, the liquid crystal display device 100 includes a content acquiring section 110, an image capturing section 120, a recording section 130, a display control section 140, a viewing angle control section 150, an operation input section 160, and a liquid crystal display section 170.

The liquid crystal display device 100 can increase a viewing angle of the liquid crystal display section 170 by use of a halftone grayscale method. The “halftone grayscale method” will be briefly described below.

In the halftone grayscale method, adjacent first and second pixels are set so that the first pixel has a gamma value higher than a predetermined reference value, whereas the second pixel has a gamma value lower than the predetermined reference value. That is, a luminance value which is higher than that in a case where the gamma value is equal to the reference value is outputted, in the first pixel, in response to an input gray scale, whereas a luminance value which is lower than that in a case where the gamma value is equal to the reference value is outputted, in the second pixel, in response to the input gray scale. Accordingly, in a case where the halftone grayscale method is employed, high luminance (bright) pixels and low luminance (dark) luminance pixels are arrayed alternately. Note that the adjacent two pixels can be subpixels into which one pixel is divided.

components of the liquid crystal display device 100 will be described below in detail.

(Content Acquiring Section 110)

The content acquiring section 110 acquires a video image content from the outside. The content acquiring section 110 acquires the video image content by, for example, demodulating a broadcast wave transmitted from a broadcasting station into data of a broadcast format which has not been modulated yet.

Alternatively, the content acquiring section 110 can acquire a content from a content recording section (not shown) such as an optical disc or a hard disk. In this case, the content acquiring section 110 can be configured to acquire a video image content from the content recording section which is directly connected to the liquid crystal display device 100 or from a content recording section (e.g., a content server) which is connected via a network.

(Image Capturing Section 120)

The image capturing section 120 is a camera section for image-capturing a subject. The image capturing section 120 includes an image capturing element which includes an electric conversion section for converting light rays passing through an image capturing lens into an electrical signal.

Note that the image capturing element includes the electric conversion section and a signal processing circuit. The electric conversion section is configured so that pixels are arranged in a central part of a surface of the image capturing element, which surface the light enters. The signal processing circuit is provided around the central part. The signal processing circuit includes components such as a driving circuit section for obtaining signal charges by driving the pixels sequentially, an analog-digital conversion section for converting the signal charges to respective digital signals, and a signal processing section for forming an image signal output with use of the digital signals.

(Recording Section 130)

The recording section 130 is a memory for recording an image which has been image-captured by the image capturing section 120. In a case where the image that has been image-captured is displayed on the liquid crystal display section 170, the image is read out from the recording section 130 and is then displayed.

It is preferred that the recording section 130 be a nonvolatile memory such as a flash memory.

(Display Control Section 140)

The display control section 140 carries out control of displaying of (i) the video image content acquired by the content acquiring section 110 or (ii) the image that has been image-captured and recorded in the recording section 130. The display control section 140 creates a menu display screen based on information that has been recorded in the recording section 130, and controls the liquid crystal display section 170 to display the menu display screen. In this case, the display control section 140 controls the liquid crystal display section 170 to display the image based on setting information of the viewing angle determined by the viewing angle control section 150. The description will not be discussed here but will be discussed below with regard to (i) when the image should be displayed with increasing the viewing angle and (ii) when the image should be displayed without increasing the viewing angle.

Furthermore, the display control section 140 controls the liquid crystal display device 100 to switch a display mode in accordance with user's operation conducted via the operation input section 160. Note that, while the menu display screen is displayed on the liquid crystal display section 170, the display control section 140 also controls the liquid crystal display section 170 to display a position of a cursor in accordance with the user's operation conducted via the operation input section 160.

(Viewing Angle Control Section 150)

The viewing angle control section 150 controls whether to increase the viewing angle of a display region in the liquid crystal display section 170. More specifically, the viewing angle control section 150 controls the liquid crystal display section 170 so that a viewing angle is increased in a display region where a natural image is displayed. The viewing angle control section 150 does not control the liquid crystal display section 170 so that a viewing angle is increased in a display region where an artificial image (geometrical pattern) containing a letter and/or a figure.

To put it another way, the viewing angle control section 150 controls the liquid crystal display section 170 so that (i) a viewing angle is increased in a display region where a natural image is displayed and (ii) a viewing angle is not increased in a display region where an artificial image containing a letter and/or a figure is displayed.

As illustrated in FIG. 1, the viewing angle control section 150 includes a region dividing section 151, a region determining section 152, and a viewing angle setting section 153. These members will be described below.

(Region Dividing Section 151)

The region dividing section 151 virtually divides, in accordance with a display mode, a display region in the liquid crystal display section 170. The region dividing section 151 notifies the display control section 140 of a display mode which has been set by the user's operation conducted via the operation input section 160. Note that how the region dividing section 151 divides the display region in the liquid crystal display section 170 is determined, in advance, in accordance with the display mode.

(Region Determining Section 152)

The region determining section 152 determines whether each of divided regions divided by the region dividing section 151 is a region where a natural image is displayed or a region where an artificial image is displayed. The region determining section 152 notifies the viewing angle setting section 153 of a result determined by the region determining section 152.

(Viewing Angle Setting Section 153)

On the basis of the result determined by the region determining section 152, the viewing angle setting section 153 sets a viewing angle so that the viewing angle is increased in a natural image display region (first region) where a natural image is displayed and does not set a viewing angle so that the viewing angle is increased in an artificial image display region (second region) where an artificial image is displayed.

“The viewing angle is not set so as to be increased” is synonymous with “no control is carried out to improve a viewing angle”. To put it another way, the viewing angle setting section 153 sets a viewing angle so that the viewing angle is increased only in the natural image display region.

The display control section 140 (i) is notified of how the viewing angle setting section 153 sets a viewing angle and then (ii) controls the liquid crystal display section 170 to display an image based on the viewing angle set by the viewing angle setting section 153.

(Operation Input Section 160)

The operation input section 160 functions as an interface via which an instruction to the liquid crystal display device 100 is accepted.

The operation input section 160 can be (i) an interface such as a keyboard via which keystroke is accepted or (ii) an interface, such as a mouse, via which a pointer to be displayed on the liquid crystal display section 170 is operated. Alternatively, the operation input section 160 can be a touch panel via which a user can carry out input by touching the liquid crystal display section 170.

(Liquid Crystal Display Section 170)

The liquid crystal display section 170 is a liquid crystal panel capable of increasing a viewing angle by use of the halftone grayscale method.

(Additional Remarks)

Note that the content acquiring section 110, the image capturing section 120, and the recording section 130 are not necessarily provided in the liquid crystal display device 100. For example, in a case where the liquid crystal display device 100 is employed as a television receiver, the image capturing section 120 and the recording section 130 are not necessarily provided. In a case where the liquid crystal display device 100 is employed as a digital still camera, the content acquiring section 110 is not necessarily provided.

In a case where the liquid crystal display device 100 is employed as a mobile phone terminal, the liquid crystal display device 100 can be configured to include the image capturing section 120 and the recording section 130 or can be alternatively configured not to include the image capturing section 120 and recording section 130.

Further, a “natural image” in the present embodiment means an image of an object which exists in the real world. Examples of the natural image encompass, in particular, (i) images constituting a video image content acquired by the content acquiring section 110 and (ii) images which have been image-captured by the image capturing section 120 and have been recorded in the recording section 130. In contrast, an “artificial image” means an image of an object which does not exist in the real world. Examples of the artificial image include (i) an image, formed in the liquid crystal display device 100, such as a menu display screen and (ii) an image which merely shows letter information.

(Operation in a Case of Digital Still Camera)

The following description will discuss how the liquid crystal display device 100 operates, for example, in a case where the liquid crystal display device 100 is employed as a digital still camera.

A user operates, via the operation input section 160, to select a display mode in which (i) an image-captured image recorded in recording section 130 and (ii) a menu display image are simultaneously displayed.

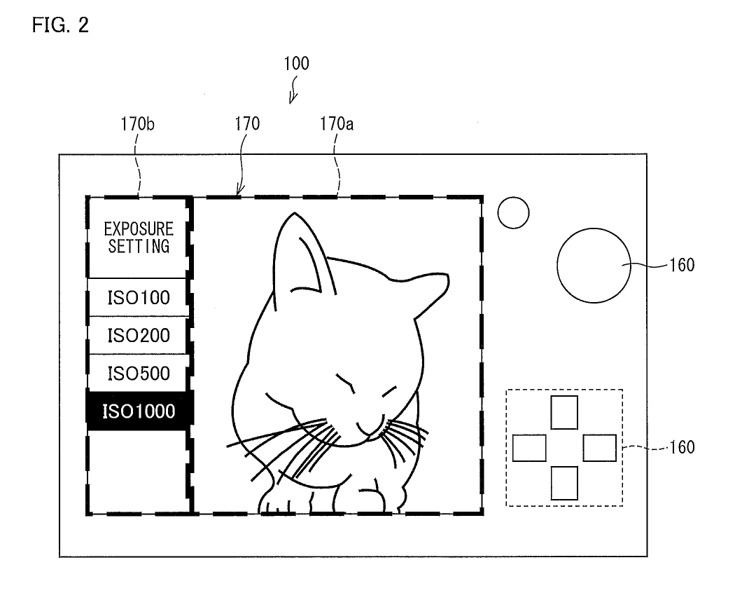

As illustrated in FIG. 2, the region dividing section 151 divides the liquid crystal display section 170 into two regions, i.e., an image-captured image display region 170a and a menu screen display region 170b. Note that positions and sizes of the image-captured image display region 170a and the menu screen display region 170b are determined in advance. The present embodiment is, however, not limited to this. Therefore, the positions and the sizes of the image-captured image display region 170a and the menu screen display region 170b can be changed by a further operation inputted by a user.

FIG. 2 is a view illustrating an example display format employed in a case where the liquid crystal display device 100 is employed as a digital still camera. Note that FIG. 2 illustrates an exposure setting screen as a menu display screen. The present embodiment is, however, limited to this. A menu display screen displayed on the menu screen display region 170b can be a screen on which a list of menu items is displayed. Alternatively, the menu display screen can display a menu item(s) which has(have) been recently specified by a user and recorded.

The display control section 140 reads out, from the recording section 130, the image-captured image specified by the user, and then controls the liquid crystal display section 170 to simultaneously display (i) the image-captured image on the image-captured image display region 170a and (ii) a created menu display screen on the menu screen display region 170b. This causes the liquid crystal display device 100 to display a state illustrated in FIG. 2. The following description will discuss how the viewing angle is set in a case where the liquid crystal display device 100 displays the state illustrated in FIG. 2.

The region determining section 152 determines that, out of the regions divided by the region dividing section 151, (i) the image-captured image display region 170a is a region where a natural image is displayed and (ii) a menu screen display region 170b is a region where an artificial image is displayed. Then, the region determining section 152 notifies the viewing angle setting section 153 of a result determined by the region determining section 152.

In this case, the region determining section 152 can also notify the viewing angle setting section 153 of the positions and the sizes of the image-captured image display region 170a and the menu screen display region 170b. The positions and the sizes of the image-captured image display region 170a and the menu screen display region 170b are not particularly limited. Therefore, any parameter can be used, provided that it can uniquely specify, in the liquid crystal display section 170, the positions and sizes of the image-captured image display region 170a and the menu screen display region 170b. For example, in a case where the image-captured image display region 170a and the menu screen display region 170b can have respective rectangular shapes, the region determining section 152 only needs to notify the viewing angle setting section 153 of position coordinates indicative of apexes of each of the image-captured image display region 170a and the menu screen display region 170b. Alternatively, the region determining section 152 can notify the viewing angle setting section 153 of a position coordinate of any of the four apexes and a length of one (1) side of the rectangle.

The viewing angle setting section 153 sets a viewing angle so that the viewing angle is increased in the image-captured image display region 170a which is determined, by the region determining section 152, to be a natural image display region. In contrast, the viewing angle setting section 153 does not set a viewing angle so that the viewing angle is increased in the menu screen display region 170b which is determined, by the region determining section 152, to be an artificial image display region.

That is, the viewing angle setting section 153 sets, on the basis of the parameter notified by the region determining section 152, (i) a region where pixels are driven so that the viewing angle is increased and (ii) a region where pixels are driven as usual. The display control section 140 controls the liquid crystal display section 170 so that (i) an image is displayed, by driving pixels so that a viewing angle is increased, on a first region set by the viewing angle setting section 153 to increase the viewing angle and (ii) an image is displayed by driving pixels as usual, on a second region other than the first region. Specifically, the display control section 140 controls the liquid crystal display section 170 as follows. Namely, pixels in the image-captured image display region 170a are driven so that any adjacent two pixels each have different luminance by use of the halftone grayscale method.

This causes (i) the image-captured image to be displayed, with increasing the viewing angle, on the image-captured image display region 170a and (ii) the menu display screen to be displayed, without increasing the viewing angle, on the menu screen display region 170b.

As described above, in the liquid crystal display device 100, a process for increasing the viewing angle is not carried out in the menu screen display region 170b illustrated in FIG. 2. It is therefore possible to prevent coarseness from occurring in edge parts of (i) a straight line and (ii) a letter, displayed on menu screen display region 170b, of the menu items. That is, the liquid crystal display device 100 can prevent display quality of the menu screen display region 170b from deteriorating in a case of a display mode in which the natural image display region 170a and the menu screen display region 170b are simultaneously displayed.

(Operation in a Case of Mobile Phone)

The following description will discuss how the liquid crystal display device 100 operates, for example, in a case where the liquid crystal display device 100 is employed as a mobile phone.

A user operates, via the operation input section 160, to select a display mode in which a video image content acquired by the content acquiring section 110 is displayed.

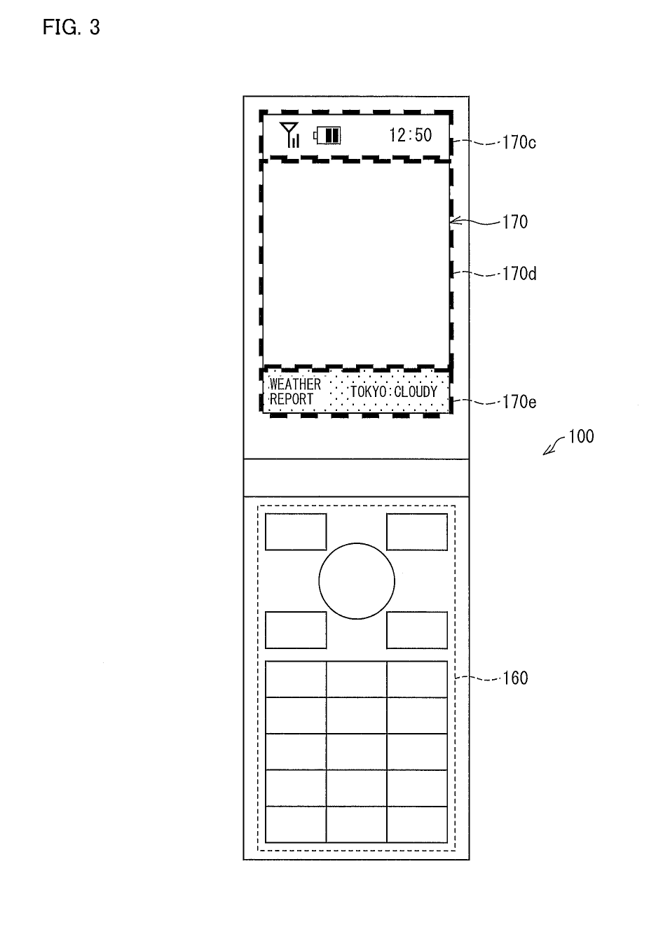

As illustrated in FIG. 3, the region dividing section 151 divides the liquid crystal display section 170 into three regions, i.e., a device information display region 170c, a content display region 170d, and a caption display region 170e. Note that, similarly to the foregoing description, positions and sizes of the device information display region 170c, the content display region 170d, and the caption display region 170e are determined in advance. However, the positions and the sizes of the device information display region 170c, the content display region 170d, and the caption display region 170e can be changed by a further operation inputted by a user. FIG. 3 is an example display format employed in a case where the liquid crystal display device 100 is employed as a mobile phone.

The display control section 140 controls the liquid crystal display section 170 to display, on the display information display region 170c, device information of the liquid crystal display device 100. The display information means information which can be recognized in the liquid crystal display device 100. In a case where the liquid crystal display device 100 is employed as a mobile phone, examples of the information encompass information indicative of an antenna level, information indicative of remaining battery charge, and information indicative of current time (see FIG. 3).

The display control section 140 controls the liquid crystal display section 170 to display, on the content display region 170d, a video image content acquired by the content acquiring section 110. The display control section 140 also controls the liquid crystal display section 170 to display, on the caption display region 170e, caption information attached to the video image content. Note that, in a case where the caption information is not attached to the video image content, the display control section 140 controls the liquid crystal display section 170 not to display anything on the caption display region 170e.

As a result, the liquid crystal display section 170 displays, for example, a state illustrated in FIG. 3. The following description will discuss how the viewing angle is set in a case where the liquid crystal display device 100 displays the state illustrated in FIG. 3.

The region determining section 152 determines that, out of the regions divided by the region dividing section 151, (i) the content display region 170d is a region where a natural image is displayed and (ii) the display information display region 170c and the caption display region 170e are regions where respective artificial images are displayed. Then, the region determining section 152 notifies the viewing angle setting section 153 of a result determined by the region determining section 152.

In this case, the region determining section 152 also notifies the viewing angle setting section 153 of positions and sizes of the device information display region 170c, the content display region 170d, and the caption display region 170e. Similarly to the foregoing description, the positions and the sizes of the device information display region 170c, the content display region 170d, and the caption display region 170e are not particularly limited. Therefore, any parameter can be used, provided that it can uniquely specify, in the liquid crystal display section 170, the positions and sizes of the device information display region 170c, the content display region 170d, and the caption display region 170e.

The viewing angle setting section 153 sets a viewing angle so that the viewing angle is increased in the display region 170d which is determined, by the region determining section 152, to be a natural image display region. In contrast, the viewing angle setting section 153 does not set a viewing angle so that the viewing angle is increased in the display information display region 170c and the caption display region 170e which are determined, in the region determining section 152, to be artificial image display regions.

The display control section 140 controls the liquid crystal display device 170 as follows. Namely, pixels in the content display region 170d are driven so that any adjacent two pixels each have different luminance by use of the halftone grayscale method.

In this way, the video image content displayed on the content display region 170d is displayed with increasing the viewing angle, whereas the device information and the caption information displayed on the display information display region 170c and the caption display region 170e, respectively, are displayed without increasing the viewing angles.

As described above, in the liquid crystal display device 100, a process for increasing the viewing angle is not carried out in the display information display region 170c and the caption display region 170e of FIG. 3. It is therefore possible to prevent coarseness from occurring in edge parts of (i) a geometrical pattern and (ii) a letter, displayed on the display information display region 170c and the caption display region 170e. That is, the liquid crystal display device 100 can prevent display quality of the display information display region 170c and the caption display region 170e from deteriorating in a case of a display mode in which (i) the video image content, constituted by natural images, and (ii) the device information and the letter information, which are the artificial images, are simultaneously displayed.

Note that, in a case where the liquid crystal display device 100 (i) is employed as a mobile phone terminal and (ii) includes the image capturing section 120 and the recording section 130, the display control section 140 can be configured to control the liquid crystal display section 170 to (i) display, on the content display region 170d, an image-captured image which is specified by a user and is read out from the recording section 130 and (ii) display a created menu display screen on the caption display region 170e.

(Operation in a Case of Television Receiver)

The following description will discuss how the liquid crystal display device 100 operates, for example, in a case where the liquid crystal display device 100 is employed as a television receiver.

A user operates, via the operation input section 160, to select a display mode in which a video image content (broadcast program), program information, and related information, which are acquired by the content acquiring section 110, are simultaneously displayed.

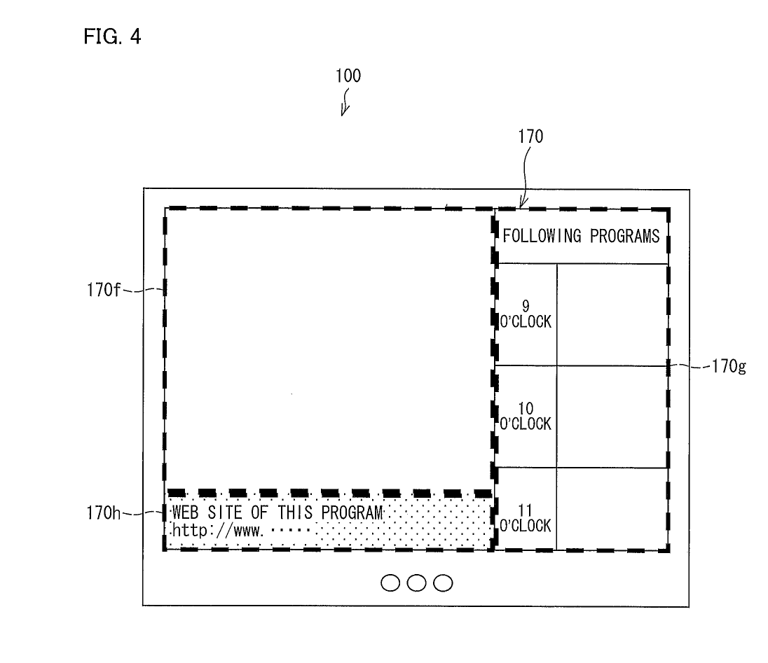

As illustrated in FIG. 4, the region dividing section 151 divides the liquid crystal display section 170 into three regions, i.e., a program display region 170f, a program information display region 170g, and a related information display region 170h. Note that, similarly to the foregoing description, positions and sizes of the program display region 170f, the program information display region 170g, and the related information display region 170h are determined in advance. The present embodiment is, however, not limited to this. Therefore, the positions and the sizes of the program display region 170f, the program information display region 170g, and the related information display region 170h can be changed by a further operation inputted by a user. FIG. 4 is a view illustrating an example display format employed in a case where the liquid crystal display device 100 is employed as a television receiver.

The display control section 140 controls the liquid crystal display section 170 to display, on the program display region 170f, a broadcast program acquired by the content acquiring section 110. The display control section 140 also controls the liquid crystal display section 170 to (i) display, on the program information display region 170g, program information attached to the broadcast program and (ii) display, on the related information display region 170h, related information related to an acquired broadcast program. Note that examples of the related information encompass information indicative of a hyperlink to a web site of the broadcast program and information on interpretation of terms taken up in the broadcast program. The related information is acquired via a network, for example, the Internet or the like.

In a case where the program information is not attached to the broadcast program and in a case where there is no related information on the network, the display control section 140 controls the liquid crystal display section 170 not to display anything on the program information display region 170g and the related information display region 170h.

This causes the liquid crystal display section 170 to display a state illustrated in FIG. 4. The following description will discuss how the viewing angle is set in a case where the liquid crystal display device 100 displays the state illustrated in FIG. 4.

The region determining section 152 determines that, out of the regions divided by the region dividing section 151, (i) the program display region 170f is a region where a natural image is displayed and (ii) the program information display region 170g and the related information display region 170h are each regions where respective artificial images are displayed. Then, the region determining section 152 notifies the viewing angle setting section 153 of a result determined by the region determining section 152.

In this case, the region determining section 152 also notifies the viewing angle setting section 153 of positions and sizes of the program display region 170f, the program information display region 170g, and the related information display region 170h. Similarly to the foregoing description, the positions and the sizes of the program display region 170f, the program information display region 170g, and the related information display region 170h are not particularly limited. Therefore, any parameter can be used, provided that it can uniquely specify, in the liquid crystal display section 170, the positions and the sizes of the program display region 170f, the program information display region 170g, and the related information display region 170h.

The viewing angle setting section 153 sets a viewing angle so that the viewing angle is increased in the program display region 170f which is determined, by the region determining section 152, to be a natural image display region. In contrast, the viewing angle setting section 153 does not set a viewing angle so that the viewing angle is increased in the program information display region 170g and the related information display region 170h which are determined to be artificial image display regions.

Accordingly, the display control section 140 controls the liquid crystal display device 170 as follows. Namely, pixels in the program display region 170f are driven so that any adjacent two pixels each have different luminance by use of the halftone grayscale method.

This causes (i) a program to be displayed, with increasing the viewing angle, on the program display region 170f and (ii) the program information and the related information to be displayed, without increasing the viewing angle, on the program information display region 170g and the related information display region 170h.

As described above, in the liquid crystal display device 100, a process for increasing the viewing angle is not carried out in the program information display region 170g and the related information display region 170h of FIG. 3. It is therefore possible to prevent coarseness from occurring in edge parts of (i) a geometrical pattern and (ii) a letter, displayed on the program information display region 170g and the related information display region 170h. That is, the liquid crystal display device 100 can prevent display quality of the program information display region 170g and the related information display region 170h from deteriorating in a case of a display mode in which the broadcast program (constituted by natural images) and the program information and the related information (which are artificial images) are simultaneously displayed.

### Modified Example

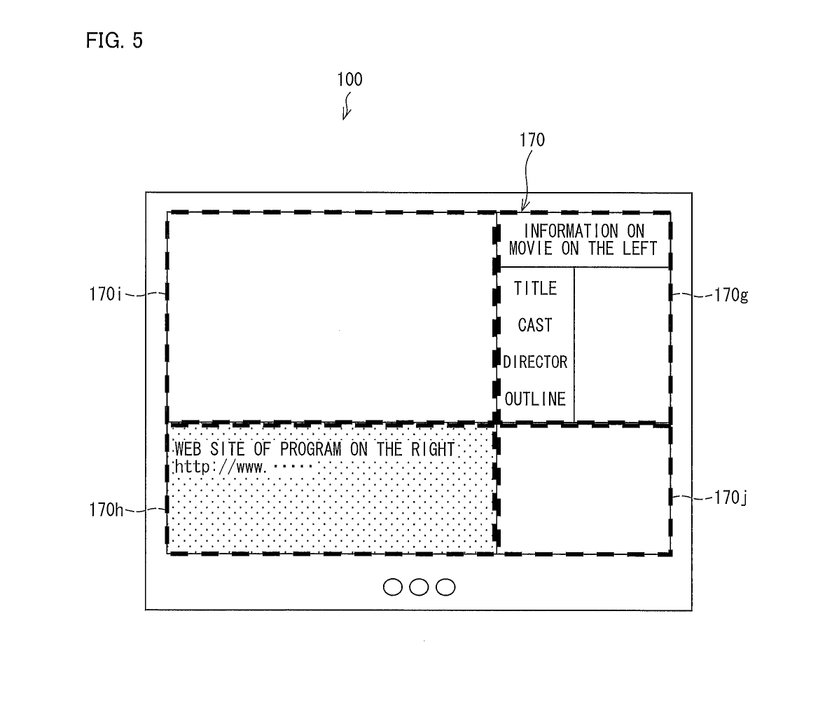

The following description will discuss a modified example where the liquid crystal display device 100 is employed as a television receiver with reference to FIG. 5.

The embodiments have discussed a case where (i) a process for increasing the viewing angle is carried out in a region where a natural image is displayed and (ii) a process for increasing the viewing angle is not carried out in a region where an artificial image is displayed. The modified example will discuss an example where, in a case where there exists a plurality of regions where respective natural images are displayed, the process for increasing the viewing angle is not carried out in part of the plurality of regions.

As illustrated in FIG. 5, the region dividing section 151 divides the liquid crystal display section 170 into three regions, i.e., a main program display region 170i, a secondary program information display region 170j, a program information display region 170g, and a related information display region 170h. Note that, similarly to the foregoing description, positions and sizes of the main program display region 170i, the secondary program information display region 170j, the program information display region 170g, and the related information display region 170h are determined in advance. The present embodiment is, however, not limited to this. Therefore, the positions and the sizes of the main program display region 170i, the secondary program information display region 170j, the program information display region 170g, and the related information display region 170h can be changed by a further operation inputted by a user. FIG. 5 is a view illustrating a modified example display format employed in a case where the liquid crystal display device 100 is employed as a television receiver.

The display control section 140 controls the liquid crystal display section 170 to display, on the main program display region 170i, a program selected by a user as a main program (program to be mainly watched) out of the broadcast programs acquired by the content acquiring section 110. The display control section 140 also controls the liquid crystal display section 170 to display, on the secondary program display region 170j, the liquid crystal display device 170, a program selected by a user as a secondary program (program to be secondarily watched) out of the broadcast programs acquired by the content acquiring section 110. Information displayed on the program information display region 170g and the related information display region 170h are similar to those as described above.

Accordingly, the liquid crystal display section 170 displays a state illustrated in FIG. 5. The following description will discuss how the viewing angle is set in a case where the liquid crystal display device 100 displays the state illustrated in FIG. 5.

The region determining section 152 determines that, out of the regions divided by the region dividing section 151, (i) the main program display region 170i and the secondary program display region 170j are regions where natural images are displayed and (ii) the program information display region 170g and the related information display region 170h are the regions where artificial images are displayed. Further, the region determining section 152 determines that the main program display region 170i is a region where an image to be mainly watched is displayed, and the secondary program display region 170j is a region where an image to be secondarily watched is displayed. Then, the region determining section 152 notifies the viewing angle setting section 153 of a result determined by the region determining section 152.

In this case, similarly to the foregoing description, the region determining section 152 also notifies the viewing angle setting section 153 of positions and sizes of the program information display region 170g, the related information display region 170h, the main program display region 170i, and the secondary program display region 170j. Therefore, any parameter can be used, provided that it can uniquely specify, in the liquid crystal display section 170, the positions and the sizes of the program information display region 170g, the related information display region 170h, the main program display region 170i, and the secondary program display region 170j.

The viewing angle setting section 153 sets a viewing angle so that the viewing angle is increased in the main program display region 170i which is determined, by the region determining section 152, to be (i) a natural image display region and also (ii) a region where an image to be mainly watched is displayed. In contrast, the viewing angle setting section 153 does not set a viewing angle so that the viewing angle is increased in the secondary program display region 170j which is determined, by the region determining section 152, to be (i) a natural image display region but (ii) a region where an image to be secondarily watched is displayed. Further, similarly to the foregoing description, the viewing angle setting section 153 does not set viewing angles so that the viewing angles are increased in the program information display region 170g and the related information display region 170h, which had been determined to be artificial image display regions.

The display control section 140 controls the liquid crystal display device 170 as follows. Namely, pixels in the main program display region 170i are driven so that any adjacent two pixels each have different luminance, by use of the halftone grayscale method.

This causes (i) a program to be displayed, with increasing the viewing angle, on the main program display region 170i and (ii) a secondary program, program information, and related information, to be displayed, without increasing the viewing angle, on the secondary program display region 170j, the program information display region 170g, and the related information display region 170h, respectively.

Accordingly, the liquid crystal display section 170 can display images on regions, where respective natural images are displayed but are not mainly watched by a user, without increasing respective viewing angles.

Note that the description has discussed an example of displaying the main program and the secondary program. The modified example is, however, not limited to such an example. For example, the liquid crystal display section 170 can secure, in case of a sport program, (i) a region where a real-time video image is displayed and (ii) a region where a video image is displayed in slow motion. In this case, the region where the video image is played in slow motion corresponds to the main program display region 170i, and the region where a real-time video image is displayed corresponds to the secondary program display region 170j.

Further, the main program display region 170i and the secondary program display region 170j can be replaced appropriately with each other in accordance with user's operation or in accordance with a video image to be displayed.

For example, in a case where an image which displays a studio in a TV station and an image which displays the scene are simultaneously displayed in a news program, (i) an image with voice can serve as the image to be mainly watched and (ii) an image with no voice can serve as the image to be secondarily watched. Alternatively, in a case where video images of respective two players who play a game such as “igo” or “shogi” (both are Japanese board games) are simultaneously displayed in a TV program, (i) an image in which a player in his/her turn is displayed can serve as the image to be mainly watched and (ii) an image in which a player, out of his/her turn, is displayed can serve as the image to be secondarily watched.

In each of the cases, regions where respective images are displayed can be replaced with each other. The image to be mainly watched can be always displayed on an upper left region in FIG. 5. Alternatively, an image displayed on the upper left can be replaced so as to be secondarily watched and an image displayed on a lower right can be replaced so as to be the image to be mainly watched, without changing the regions where the images are displayed.

(Program and Recording Medium)

The display control section 140 and the viewing angle control section 150, which are included in the liquid crystal display device 100, can be configured by means of hardware logic or can alternatively be realized by software with use of a CPU (Central Processing Unit) as follows.

Specifically, the display control section 140 and the viewing angle control section 150 each include: a CPU, such as an MPU, for executing commands of a program to realize each function; a ROM (Read Only Memory) which stores the program; a RAM (Random Access Memory) in which the program is developed in an executable format; and a storage device (recording medium), such as a memory, which stores the program and various kinds of data.

Further, the object of the present invention can be achieved not only by causing the liquid crystal display device 100 to execute the program stored, in a fixed manner, in the program memories of the display control section 140 and the viewing angle control section 150, but also by (i) providing, to the liquid crystal display device 100, a recording medium in which program codes of the program (execution format program, intermediate code program, or a source program) is recorded and (ii) causing the liquid crystal display device 100 to execute the program code read out from the recording medium.

The recording medium is not limited to a specific structure and/or a specific kind. That is, examples of the recording medium include: tape-type recording media such as a magnetic tape and a cassette tape; disk-type recording media such as (i) magnetic disks such as a floppy (registered trademark) disk and a hard disk and (ii) optical discs such as a CD-ROM, an MO, an MD, a DVD, and a CD-R; card-type recording media such as an IC card (including a memory card) and an optical card; and semiconductor-memory-type recording media such as a mask ROM, an EPROM, an EEPROM, and a flash ROM.

Alternatively, the object of the present invention can be attained by configuring the display control section 140 and the viewing angle control section 150 (or the liquid crystal display device 100) so as to be connectable to a communication network. In this case, the program code are provided to the display control section 140 and the viewing angle control section 150, via the communication network. The communication network is not limited to a specific kind and/or a specific mode (i.e., any communication network can be used), provided that the program code can be provided via the communication network to the display control section 140 and the viewing angle control section 150. Examples of the communication network include the internet, an intranet, an extranet, a LAN, an ISDN, a VAN, a CATV communication network, a virtual private network, a telephone network, a mobile communication network, and a satellite communication network.

The transmission medium constituting the communication network is not limited to a specific configuration and/or a specific kind (i.e., any transmission medium can be used), provided that the transmission medium can transmit the program code. Examples of the transmission medium encompass (i) wired transmission media such as IEEE1394, a USB, power-line carrier, a cable TV line, a telephone line, and an ADSL (Asymmetric Digital Subscriber Line) and (ii) wireless transmission media such as infrared rays (e.g., IrDA and a remote controller), Bluetooth (registered trademark), 802.11 wireless, an HDR, a cell-phone network, and a satellite line, and a digital terrestrial network. Note that the present invention can be realized by use of computer data signal in which the program code is embodied by electronic transmission or computer data signal embedded in a carrier wave.

(Additional Remarks)

It is preferable that a liquid crystal display device of the present invention, further includes: image capturing means for image-capturing a subject; and a recording section for storing an image-captured image indicative of the subject which has been image-captured by the image capturing means, the display means displaying, on the first region, the image-captured image read out from the recording section.

According to the arrangement, the viewing angle is increased so that many people can enjoy an image-captured image. This makes it possible to suitably use the liquid crystal display device in an image-capturing device.

It is further preferable that the liquid crystal display device of the present invention includes: content acquiring means for acquiring a video image content from outside, the displaying means displaying, on the first region, images in a predetermined order, the images constituting the video image content which has been acquired by the content acquiring means.

According to the arrangement, the viewing angle is increased so that many people can enjoy images constituting a video image content. This makes it possible to suitably use the liquid crystal display device in a content player.

Further, it is preferable that, in the liquid crystal display device of the present invention, the first region includes a main image display region where a main image is displayed and a sub-image display region where a sub-image is displayed, and the display means (i) displays the main image by driving a pixel in the main image display region of the first region so that a viewing angle is increased and (ii) displays the sub-image by driving a pixel in the sub-image display region of the first region so that a viewing angle is not increased.

According to the arrangement, in the first region where a natural image is displayed, the viewing angle is increased only in a region where a main image is displayed.

It is therefore possible to display the sub-image by driving the sub-image display region, where the sub-image is displayed, so that the viewing angle is not increased, even in a case where the sub-image display region is the first region where a natural image is displayed.

This makes it possible, for example, to display an image whose viewing angle is increased only in a region where the image is mainly watched by a user.

In order to achieve the object, a method, according to the present invention, for displaying an image in a liquid crystal display device in which a viewing angle of a liquid crystal panel can be increased by setting any adjacent two pixels so that one of the any adjacent two pixels has a gamma value higher than a predetermined reference gamma value and the other of the any adjacent two pixels has a gamma value lower than the predetermined reference gamma value, said method includes the steps of: dividing a display region of the liquid crystal panel into (a) a first region where a natural image is displayed and (b) a second region where an artificial image is displayed; and displaying the natural image by driving a pixel in the first region so that a viewing angle is increased, and displaying the artificial image by driving a pixel in the second region so that a viewing angle is not increased.

The arrangement brings about an effect similar to that of the liquid crystal display device of the present invention.

Further, (A) a program for causing a computer in the liquid crystal display device of the present invention to operate, which program causes the computer to function as each means of the liquid crystal display device, and (B) a computer readable recording medium in which the program is recorded are also included within the scope of the present invention.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

A liquid crystal display device of the present invention can be used in overall devices, each of which includes a liquid crystal display section, such as a digital still camera, portable information terminal (e.g., mobile phone), and a television receiver.

### REFERENCE SIGNS LIST

100 liquid crystal display device
110 content acquiring section
120 image capturing section
130 recording section
140 display control section (display means)
150 viewing angle control section
151 region dividing section
152 region determining section
153 viewing angle setting section
160 operation input section
170 liquid crystal display section (liquid crystal panel)
170a image-captured image display region (first region)
170b menu screen display region (second region)
170c information display region (second region)
170d content display region (first region)
170e caption display region (second region)
170f program display region (first region)
170g program information display region (second region)
170h related information display region (second region)
170i main program display region (main image display region)
170j secondary program display region (sub-image display region)

1. A liquid crystal display device in which a viewing angle of a liquid crystal panel can be increased by setting any adjacent two pixels so that one of any adjacent two pixels has a gamma value higher than a predetermined reference gamma value and the other of the any adjacent two pixels has a gamma value lower than the predetermined reference gamma value,
said liquid crystal display device comprising:
region dividing means for dividing a display region of the liquid crystal panel into (a) a first region where a natural image is displayed and (b) a second region where an artificial image is displayed; and
display means for (i) displaying the natural image by driving a pixel in the first region so that a viewing angle is increased and (ii) displaying the artificial image by driving a pixel in the second region so that a viewing angle is not increased.

2. A liquid crystal display device as set forth in claim 1, further comprising:
image capturing means for image-capturing a subject; and
a recording section for storing an image-captured image indicative of the subject which has been image-captured by the image capturing means,
the display means displaying, on the first region, the image-captured image read out from the recording section.

3. A liquid crystal display device as set forth in claim 1, further comprising
content acquiring means for acquiring a video image content from outside,
the displaying means displaying, on the first region, images in a predetermined order, the images constituting the video image content which has been acquired by the content acquiring means.

4. A liquid crystal display device as set forth in claim 1, further comprising:
image capturing means for image-capturing a subject;
a recording section for storing an image-captured image indicative of the subject which has been image-captured by the image capturing means; and
content acquiring means for acquiring a video image content from outside,
the display means displaying, on the first region, one of (i) the image-captured image read out from the recording section and (ii) images constituting the video image content which has been acquired by the content acquiring means.

5. The liquid crystal display device as set forth in claim, wherein:
the first region includes a main image display region where a main image is displayed and a sub-image display region where a sub-image is displayed, and
the display means (i) displays the main image by driving a pixel in the main image display region of the first region so that a viewing angle is increased and (ii) displays the sub-image by driving a pixel in the sub-image display region of the first region so that a viewing angle is not increased.

6. A method for displaying an image in a liquid crystal display device in which a viewing angle of a liquid crystal panel can be increased by setting any adjacent two pixels so that one of the any adjacent two pixels has a gamma value higher than a predetermined reference gamma value and the other of the any adjacent two pixels has a gamma value lower than the predetermined reference gamma value,
said method comprising the steps of:
dividing a display region of the liquid crystal panel into (a) a first region where a natural image is displayed and (b) a second region where an artificial image is displayed; and
displaying the natural image by driving a pixel in the first region so that a viewing angle is increased, and displaying the artificial image by driving a pixel in the second region so that a viewing angle is not increased.

7. A program for causing a computer in a liquid crystal display device recited in claim 1 to operate, the program causing the computer to function as each means of the liquid crystal display device.

8. A computer readable recording medium in which the program recited in claim 7 is recorded.
